(19) United States
(12) Patent Application Publication
(10) Pub. No.: US 2004/0193507 A1
(43) Pub. Date: Sep. 30, 2004

(54) Business transaction program and record medium

(75) Inventors: Kosei Takano, Tokyo (JP); Hiroshi Kuzumaki, Tokyo (JP); Tomotaka Ono, Kawasaki (JP); Kazuaki Honda, Tokyo (JP); Hiroshi Inagawa, Tokyo (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/788,206

(22) Filed: Feb. 27, 2004

(30) Foreign Application Priority Data
Mar. 24, 2003 (JP) 2003-079656

(51) Int. Cl. G06F 17/60

(52) U.S. Cl. 705/27

(57) ABSTRACT

A business transaction program that enables a user to easily learn learning content he/she wants to. A transaction screen display section in a computer displays a transaction screen for conducting transaction on a terminal unit used by a user for conducting and learning the transaction in response to a request from the terminal unit. When a learning request for the transaction is made from the terminal unit, a content display section obtains learning content corresponding to the transaction on the transaction screen displayed on the terminal unit from a learning content database and displays it on the terminal unit. When a search by a keyword is performed from the terminal unit, learning content which matches the keyword may not reside in the learning content database. In this case, a content search section searches a server for such learning content via a network. The server stores various types of learning content to be provided to companies.

### BACKGROUND OF THE INVENTION

(1) Field of the Invention

This invention relates to a business transaction program and a record medium and, more particularly, to a business transaction program and a record medium which enable a user to learn about transaction in the middle of conducting the transaction.

(2) Description of the Related Art

Conventionally, e-learning has been used for in-house training and a user seeks trainings regarding his/her transaction for himself/herself and receives them. A optimum training recommendation unit for comparing the skill trend of trainee and the standard skill trend to recommend the optimum trainings for him/her is proposed as a unit that saves him/her the trouble of seeking necessary trainings for himself/herself (see, for example, Japanese Unexamined Patent Publication No. 2002-72848 (p. 3 and FIG. 1)).

However, the above optimum training recommendation unit does not suggest learning (training) a user really wants to receive, but learning most suitable for him/her. Accordingly, it has been hoped that a user can easily receive learning for his/her transaction in the middle of the conduct of the transaction without seeking them for himself/herself.

Furthermore, if an in-house server does not store learning content related to transaction a user desires, then he/she cannot learn about it.

### SUMMARY OF THE INVENTION

The present invention was made under the background circumstances described above. An object of the present invention is to provide a business transaction program and record medium which can provide learning content for transaction displayed on a transaction screen in response to a learning request for transaction made on the transaction screen.

Another object of the present invention is to provide a business transaction program and record medium for searching an external server for learning content and for providing a user with learning he/she desires.

In order to achieve the above objects, a business transaction program for conducting transaction is provided. This business transaction program makes a computer perform the processes of displaying a transaction screen used by a user for conducting transaction on a terminal unit in response to a request from the terminal unit, displaying, in the case of a learning request for transaction being made on the transaction screen displayed on the terminal unit, learning content for learning about transaction to be conducted on the transaction screen on the terminal unit, and retrieving, in case the learning content is searched on the transaction screen by a keyword and learning content which matches the keyword does not reside in a database in the computer, learning content which matches the keyword from an external server and displaying the learning content on the terminal unit.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a view for describing the principles underlying the present invention.

FIG. 2 shows an exemplary of the structure of an embodiment of the present invention.

FIG. 3 is a block diagram showing the hardware structure of a transaction server.

FIG. 4 is a functional block diagram of a transaction server.

FIG. 5 shows an exemplary of the data structure of a user information database.

FIG. 6 shows an exemplary of the data structure of a learning history database.

FIG. 7 shows an exemplary of data stored in a transaction database.

FIG. 8 shows an exemplary of the data structure of a transaction tree link table.

FIG. 9 shows an exemplary of the data structure of a teaching material link table.

FIG. 10 shows an exemplary of the data structure of a teaching material database.

FIG. 11 shows an exemplary of the data structure of a retrieved teaching material accumulation table.

FIG. 12 shows an exemplary of the data structure of an in-house terminology dictionary database.

FIG. 13 shows a first transaction screen displayed on a terminal unit.

FIG. 14 shows a screen on a terminal unit where transaction items at lower hierarchy levels are displayed.

FIG. 15 shows a transaction screen displayed on a terminal unit.

FIG. 16 shows a learning screen displayed on a terminal unit.

FIG. 17 shows a learning screen for learning how to describe an exemplary which is displayed on a terminal unit.

FIG. 18 shows a specific learning screen displayed on a terminal unit.

FIG. 19 shows a screen displayed on a terminal unit at the time of searching by a keyword.

FIG. 20 shows the result of a search displayed on a terminal unit.

FIG. 21 shows a learning screen for learning teaching material content retrieved from an external server.

FIG. 22 is a first flow chart showing a process performed by a transaction server to provide transaction and teaching material content.

FIG. 23 is a second flow chart showing a process performed by the transaction server to provide transaction and teaching material content.

FIG. 24 is a flow chart showing a process performed by a transaction server to add teaching materials content.

### DESCRIPTION OF THE PREFERRED EMBODIMENTS

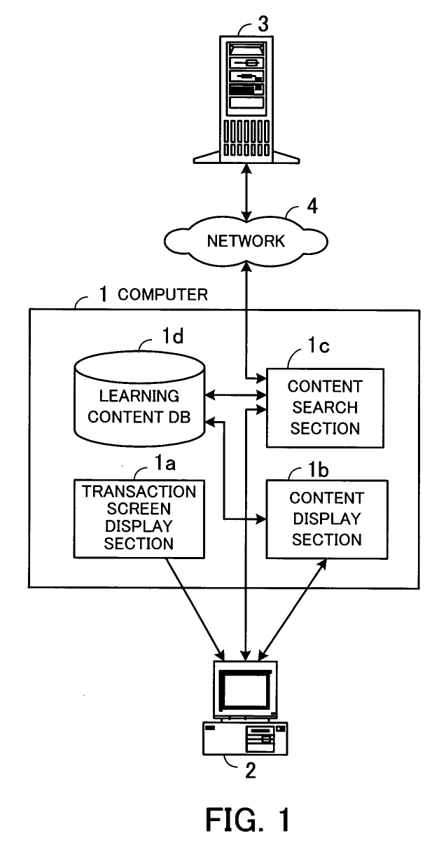

Embodiments of the present invention will now be described with reference to the drawings. FIG. 1 is a conceptual view of the present invention. A computer 1 includes a transaction screen display section 1a, a content display section 1b, a content search section 1c, and a learning content database id to execute a business transaction program according to the present invention. The computer 1 and a terminal unit 2 are possessed by one company and are connected in the company. A server 3 is the one possessed by, for example, an external educational software vendor and is connected to the computer 1 via a network 4. The learning content database 1d stores learning content used for transaction learning.

The transaction screen display section la displays a transaction screen for conducting transaction on the terminal unit 2 in response to a request from the terminal unit 2.

When a learning request for transaction is made from the terminal unit 2, the content display section 1b obtains learning content corresponding to the transaction on a transaction screen displayed on the terminal unit 2 from the learning content database Id and displays it on the terminal unit 2.

When a search by a keyword is performed from the terminal unit 2, learning content which matches the keyword may not reside in the learning content database 1d. In this case, the content search section 1c searches the server 3 for such learning content via the network 4.

The terminal unit 2 is used by a user for conducting and learning transaction. The server 3 stores various types of learning content to be provided to companies.

Operation in FIG. 1 will now be described.

A user uses the terminal unit 2 for conducting his/her transaction. The user makes a request to the computer 1 with the terminal unit 2 for a transaction screen for conducting his/her transaction.

The transaction screen display section la in the computer 1 displays a transaction screen on the terminal unit 2 in response to the request from the terminal unit 2.

When the user does not know, for example, how to conduct his/her transaction on the transaction screen displayed on the terminal unit 2, he/she requests the computer 1 for his/her transaction learning.

The content display section 1b in the computer 1 obtains learning content corresponding to the transaction on the transaction screen displayed on the terminal unit 2 from the learning content database id and displays it on the terminal unit 2. This enables the user to easily learn about the transaction he/she is conducting without seeking the learning content for himself/herself.

If learning content which corresponds to the transaction on the transaction screen displayed on the terminal unit 2 and which the user wants to learn does not exist, then he/she searches for such learning content by a keyword.

The content search section 1c in the computer 1 searches the learning content database 1d for such learning content in response to the search by a keyword from the terminal unit 2. If learning content which matches the keyword does not reside in the learning content database 1d, then the content search section 1c searches the server 3 for such learning content via the network 4. The content search section 1c displays learning content it retrieved from the server 3 on the terminal unit 2. As a result, even if learning content which the user wants to learn does not reside on the computer 1, he/she can learn about such learning content stored in the external server 3.

As stated above, when a learning request for transaction is made from a transaction screen displayed on the terminal unit, learning content for learning transaction on the transaction screen is displayed on the terminal unit. When a search of learning content by a keyword is performed on the transaction screen, the learning content is retrieved from the external server and is displayed on the terminal unit. As a result, a user can learn about his/her transaction easily by requesting on a transaction screen to make him/her learn. Moreover, learning content is retrieved from the external server. Therefore, even if learning content which a user wants to learn is not stored in the computer 1, he/she can receive learning he/she wants to.

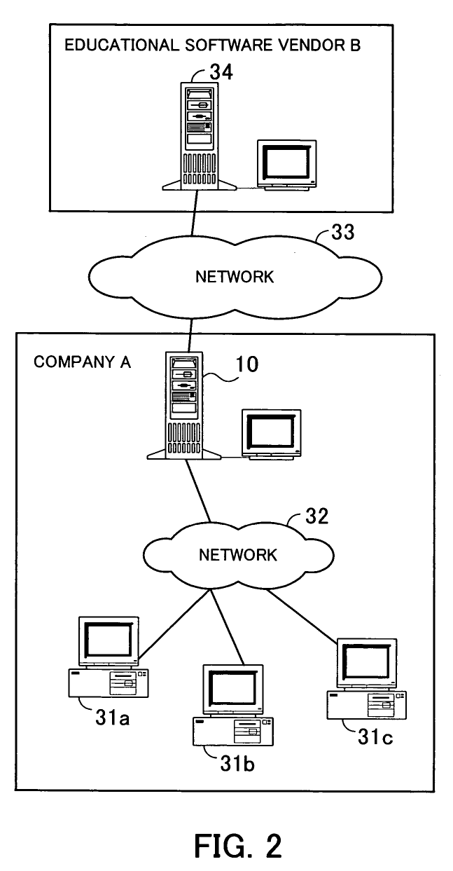

Now, a transaction server for executing a business transaction program according to the present invention will be described. FIG. 2 shows an exemplary of the structure of an embodiment of the present invention. As shown in FIG. 2, a transaction server 10 is connected to terminal units 31a through 31c via a network 32. The transaction server 1 and the terminal units 31a through 31c form a network in company A. The network 32 is, for example, an intranet.

In addition, the transaction server 10 is connected via a network 33 to a server 34 possessed by external educational software vendor B. The transaction server 10 communicates with the server 34 via the network 33. The network 33 is, for example, the Internet. An overview of FIG. 2 will now be given.

The terminal units 31a through 31c are used by employees (users) of the company A for conducting their transactions. A user uses one of the terminal units 31a through 31c, displays a transaction screen for conducting target transaction (transaction is of a plurality of types), and conducts his/her transaction. If the user does not know how to conduct his/her transaction, then he/she requests for transaction learning on the transaction screen where he/she is conducting his/her transaction to the transaction server 10. This to the transaction server 10 screen is a portal site customized solely for the user.

When a learning request is made from one of the terminal units 31a through 31c, the transaction server 10 displays learning content for transaction learning on the transaction screen displayed on the terminal unit. That is to say, if the user does not know how to conduct his/her transaction on the transaction screen, then he/she should make a request on the transaction screen to learn. By doing so, the user can learn about the transaction.

If the above learning content is not what the user wants to learn, then he/she can search for such content from the terminal unit by a keyword. When a search by a keyword is performed from the terminal unit, the transaction server 10 searches databases stored therein for such learning content. If learning content which matches the keyword does not reside in the databases stored in the transaction server 10, then the transaction server 10 searches the server 34 possessed by the educational software vendor B for such learning content via the network 33. That is to say, if learning content the user wants to learn does not reside in the databases stored in the transaction server 10, then the transaction server 10 searches the external server 34 for such learning content. Therefore, the user can learn learning content he/she wants to.

The transaction server 10 is possessed by the company A, but it may be possessed by another company, such as an external provider connected to the network 33. In this case, a user will access the transaction server 10 possessed by a provider from one of the terminal units 31a through 31c via the network 33, conduct his/her transaction, and perform learning.

FIG. 2 shows only one educational software vendor and only one server possessed by the educational software vendor. However, there are a plurality of educational software vendors and each of them possesses a plurality of servers. The transaction server 10 searches servers possessed by a plurality of educational software vendors for learning. content which matches a keyword.

The function of the transaction server 10 which enables a user to conduct his/her transaction will now be described in detail.

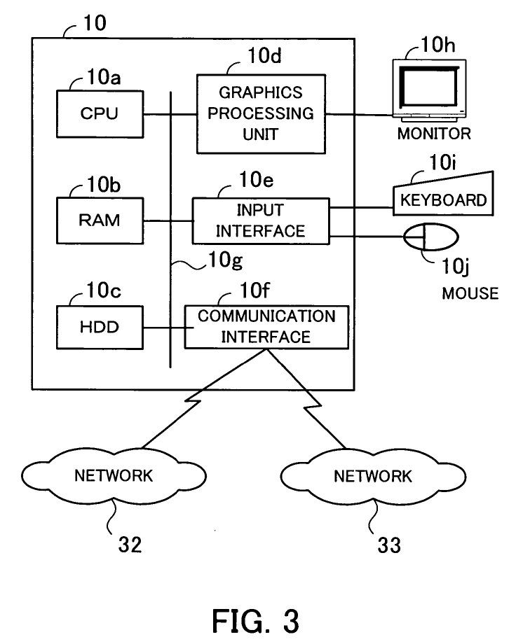

FIG. 3 is a block diagram showing the hardware structure of the transaction server. The whole of the transaction server 10 shown in FIG. 3 is controlled by a central processing unit (CPU) 10a. A random access memory (RAM) 10b, a hard disk drive (HDD) 10c, a graphics processing unit 10d, an input interface 10e, and a communication interface 10f are connected to the CPU 10a via a bus 10g.

RAM 10b temporarily stores at least part of an operating system (OS) program or an application program executed by the CPU 10a. The RAM 10b stores various data necessary for processing. by the CPU 10a. The HDD 10c stores an OS program and application programs.

A monitor 10h is connected to the graphics processing unit 10d. The graphics processing unit 10d displays an image on a screen of the monitor 10h in accordance with instructions from the CPU 10a. A keyboard 10i and a mouse 10j are connected to the input interface 10e. The input interface 10e sends signals sent from the keyboard 10i or the mouse 10j to the CPU 10a via the bus 10g.

The communication interface 10f is connected to the networks 32 and 33. The communication interface 10f communicates with the terminal units 31a through 31c in the company A via the network 32. The communication interface 10f also communicates with the external server 34 via the network 33.

The hardware structure of the terminal units 31a through 31c is the same as that shown in FIG. 3.

By adopting the above hardware structure, the processing function of this embodiment can be realized.

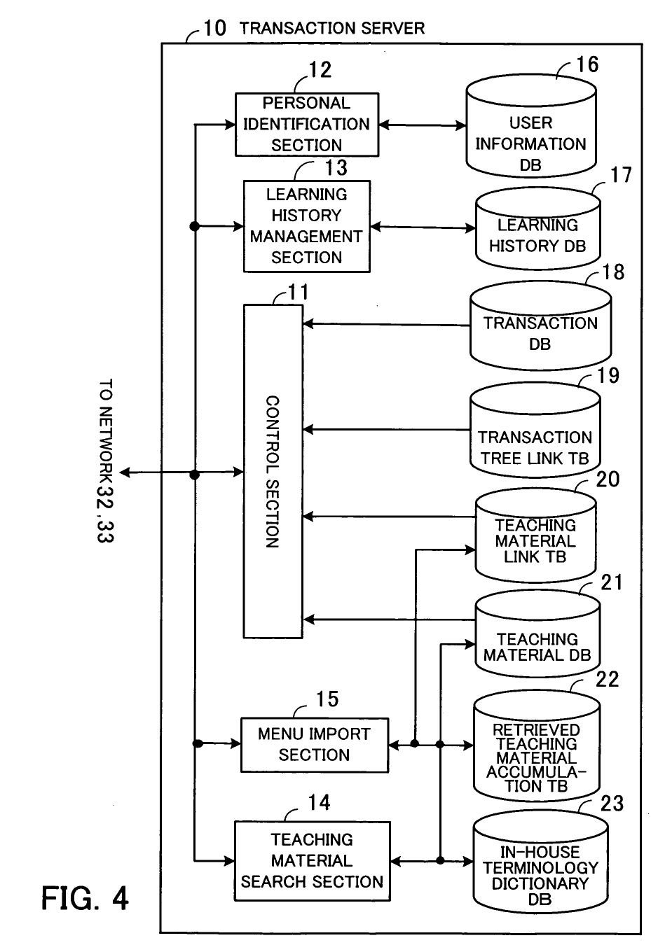

FIG. 4 is a functional block diagram of the transaction server. The transaction server 10 includes a control section 11, a personal identification section 12, a learning history management section 13, a teaching material search section 14, a menu import section 15, a user information database 16, a learning history database 17, a transaction database 18, a transaction tree link table 19, a teaching material link table 20, a teaching material database 21, a retrieved teaching materials accumulation table 22 and an in-house terminology dictionary database 23.

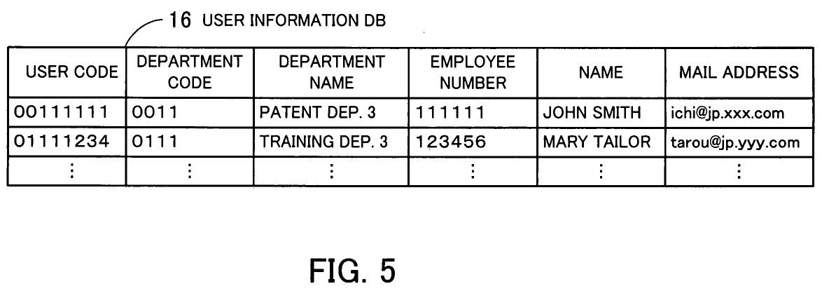

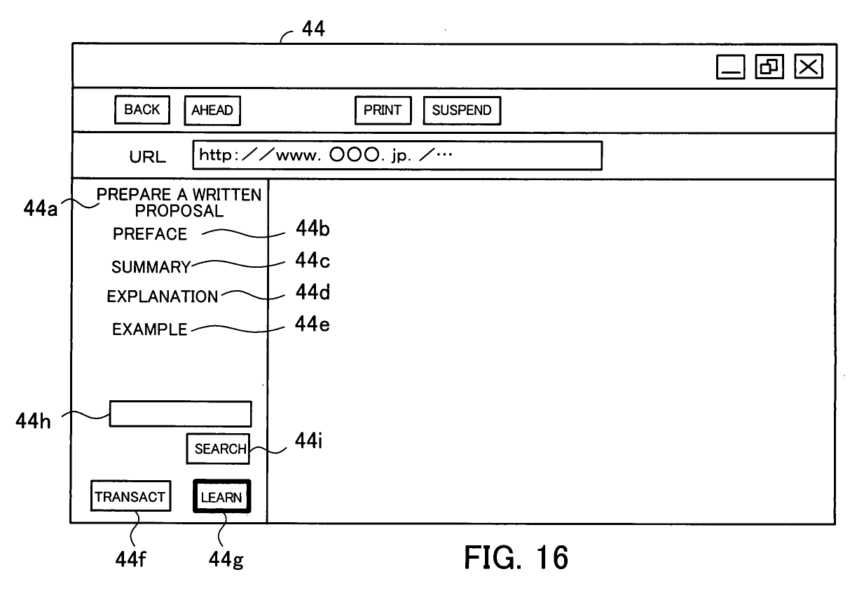

The data structure of the databases and data tables will be described first. Information regarding users who will use the terminal units 31a through 31c is stored in advance in the user information database 16. FIG. 5 shows an exemplary of the data structure of the user information database. As shown in FIG. 16, the user information database 16 includes columns labeled “User Code”, “Department Code”, “Department Name”, “Employee Number”, “Name”, and “Mail Address”.

Identification numbers assigned to users who will use the terminal units 31a through 31c are stored in the column “User Code”. The identification numbers of departments of the company A to which the users belong are stored in the column “Department Code”. Employee numbers assigned to the users by the company A are stored in the column “Employee Number”. The names of the users are stored in the column “Name”. The mail addresses of the users are stored in the column “Mail Address”.

In this example, “John Smith” is stored in the user information database 16 as the name of a user. In addition, “00111111,” being his/her user code, is stored. “Patent Department 3,” being the name of the department to which he belongs, is stored. “111111,” being his employee number, is stored. “ichi@jp.xxx.com,” being his mail address, is stored.

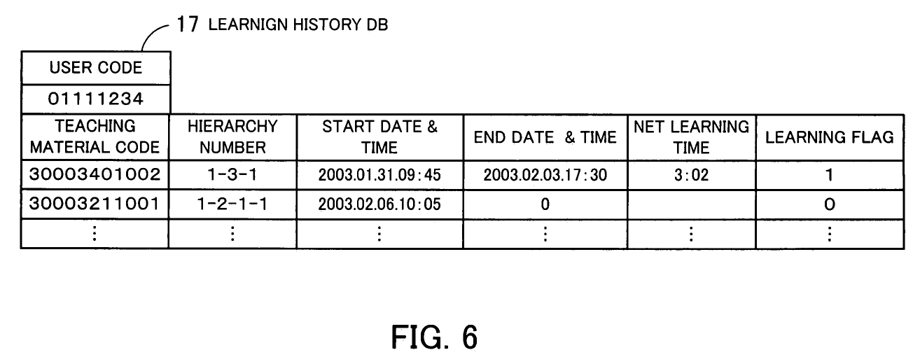

Information regarding learning content (teaching material content) which users learned is stored in the learning history database 17. FIG. 6 shows an exemplary of the data structure of the learning history database. As shown in FIG. 6, the learning history database 17 includes columns labeled “User Code”, “Teaching Material Code”, “Hierarchy Number”, “Start Date and Hour”, “End Date and Hour”, “Net Learning Time”, and “Learning Flag”. The learning history database 17 contains a teaching material code, a hierarchy number, a start date and hour, an end date and hour, net learning time, and a learning flag corresponding to each user code, that is to say, corresponding to each user.

The identification numbers of users who used teaching material content for transaction learning are stored in the column “User Code”. The identification numbers of teaching material content which the users used are stored in the column “Teaching Material Code”. The hierarchy numbers of transaction (transaction screens) for which teaching material content was retrieved are stored in the column “Hierarchy Number” (a more detailed description will be given later). The dates and hours at which the users began to learn are stored in the column “Start Date and Hour”. The dates and hours at which the users finished learning are stored in the column “End Date and Hour”. Total time during which the users learned teaching materials is stored in the column “Net Learning Time”. Flags indicative of whether the users finished learning are stored in the column “Learning Flag”. For example, the flag “1” indicates that learning is finished, and the flag “0” indicates that learning is not finished.

In this example, the learning history of the user whose user code is “01111234” is stored in the learning history database 17. This learning history indicates that the user used teaching materials the teaching material code of which is “30003401002”. This learning history indicates that the user retrieved the teaching materials from transaction the hierarchy number of which is “1-3-1”. This learning history indicates that the user began to learn at 9:45 a.m., Jan. 31, 2003. This learning history indicates that the user finished learning at 5:30 p.m., Feb. 3, 2003. This learning history indicates that net learning time is three hours and two minutes. The learning flag “1” corresponding to the teaching material code “30003401002” indicates that the user finished learning these teaching materials.

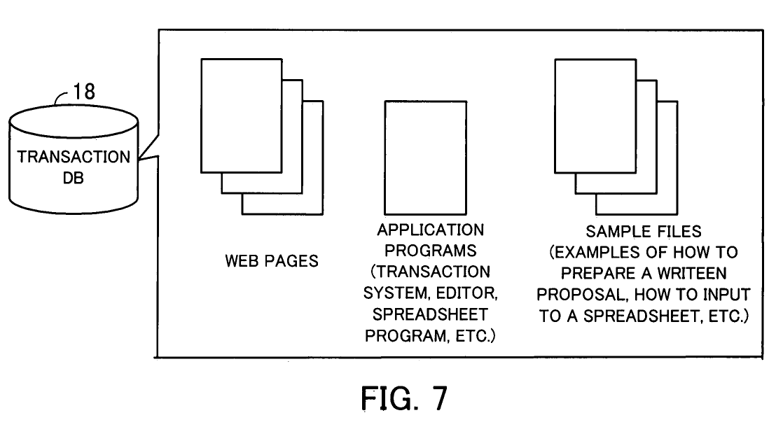

The transaction database 18 stores Web page data displayed on the screens of the terminal units 31a through 31c, application programs for conducting transaction, and sample files each of which shows an example of input provided for conducting transaction. FIG. 7 shows an exemplary of data stored in the transaction database. The transaction database 18 stores Web page data (created in hypertext markup language (HTML)) necessary for displaying screens corresponding to the contents of transaction on the terminal units 31a through 31c. The transaction database 18 stores application programs (transaction systems) for conducting transaction. These application programs are used for searching for a file, sending and receiving mail, placement of transaction-related orders, settling accounts, and the like. The transaction database 18 also stores an editor for preparing a written proposal on sales and a spreadsheet program for inputting the amount of incomings and outgoings. In addition, the transaction database 18 stores sample files which show examples of how to prepare a written proposal and how to input the amount of money into a spreadsheet.

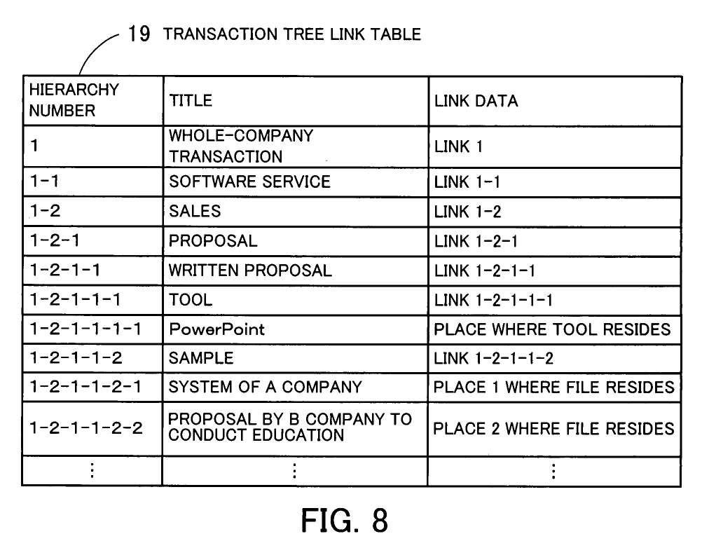

The transaction tree link table 19 shows the hierarchical structure of transaction. FIG. 8 shows an exemplary of the data structure of the transaction tree link table. As shown in FIG. 8, the transaction tree link table 19 contains the columns labeled “Hierarchy Number”, “Title”, and “Link Data”.

The hierarchy numbers assigned to the respective items of transactions are stored in the column “Hierarchy Number”. FIG. 8 indicates that the more hyphens the hierarchy number includes as separators, the deeper in the hierarchy the corresponding transaction is. The transaction database 18 stores Web pages corresponding to transaction screens, applications which users can use for conducting their transactions, and sample files, such as the one showing an example of how to prepare a written proposal, which users can use for reference, and the titles of these Web pages, applications, and sample files are stored in the column “Title”. Link data indicative of places where Web pages, applications, and sample files bearing these titles are stored is stored in the column “Link Data”. Such link data is represented in, for example, uniform resource locator (URL) form. A hierarchy number corresponds to each transaction screen displayed on the terminal units 31a through 31c and serves as an identifier therefor.

In this example, “whole-company transaction” is at the highest hierarchy level of transaction. “Software service” and “sales” are at the next highest hierarchy level of transaction. The hierarchy levels of “proposal”, “written proposal,” etc. are lower than that of “sales”. Link data corresponding to “written proposal” is “link 1-2-1-1,” so written proposal data will reside at the link 1-2-1-1.

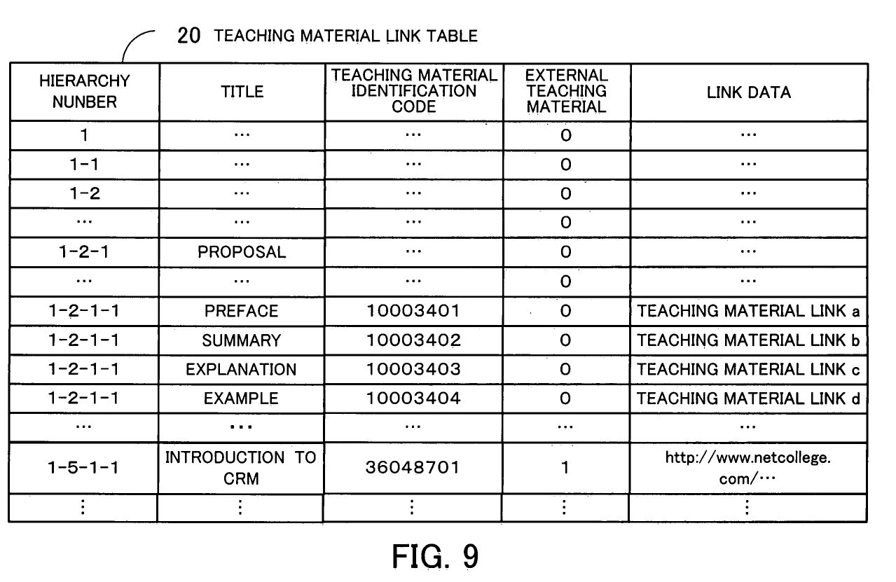

The teaching material link table 20 shows places where teaching material content used by users for learning is stored. FIG. 9 shows an exemplary of the data structure of the teaching material link table. As shown in FIG. 9, the teaching material link table 20 contains the columns labeled “Hierarchy Number”, “Title”, “Teaching Material Identification Code”, “External Teaching Materials”, and “Link Data”.

Hierarchy numbers corresponding to those contained in the transaction tree link table 19 are stored in the column “Hierarchy Number”. The titles of teaching material content are stored in the column “Title”. Identification numbers for identifying the teaching material content are stored in the column “Teaching Material Identification Code”. Identifiers indicative of whether the teaching material content is stored in the teaching material database 21 or in the external server 34 possessed by the educational software vendor B are stored in the column “External Teaching Materials”. In the column “External Teaching Materials” of FIG. 9, “0” indicates that teaching material content is stored in the teaching material database 21, and “1” indicates that teaching material content is stored in the external server 34 possessed by the educational software vendor B. In the column “Link Data” is stored link data showing locations where teaching material contents are stored. Such link data is represented in, for example, URL form.

In FIG. 9, the titles “preface,” “summary,” “explanation,” and “example” correspond to the hierarchy number “1-2-1-1”. The teaching material identification code “10003401,” the external teaching materials “0,” and the link data “teaching material link a” correspond to the title “preface”. The external teaching materials “1” corresponds to the title “introduction to CRM” and indicates that teaching material data is stored in the external server 34 possessed by the educational software vendor B. In addition, the link data “http://www.netcollege.com/. . .” corresponds to the title “introduction to CRM”.

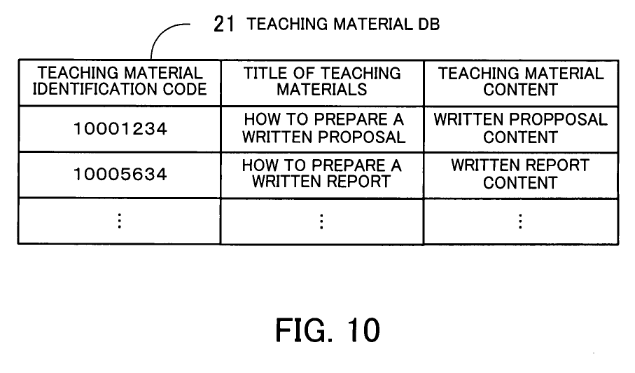

The teaching material database 21 stores teaching material contents allowing users to learn about transactions. FIG. 10 shows an exemplary of the data structure of the teaching material database. As shown in FIG. 10, the teaching material database 21 includes columns labeled “Teaching Material Identification Code”, “Title of Teaching Materials”, and “Teaching Material Content”.

Identification numbers for identifying teaching materials are stored in the column “Teaching Material Identification Code”. The titles of the teaching materials are stored in the column “Title of Teaching Materials”. The contents of teaching materials allowing users to learn about their transactions are stored in the column “Teaching Material Content”.

As stated above, the hierarchy numbers shown in FIG. 9 correspond to those shown in FIG. 8. It is assumed that a transaction screen corresponding to the hierarchy number “1-2-1-1” shown in FIG. 8 is displayed on one of the terminal units 31a through 31c. When a learning request is made on this screen, link data in FIG. 9 corresponding to the hierarchy number “1-2-1-1” is referred to and teaching material content which resides at teaching material links a through d in the teaching material database 21 is displayed on the screen of the terminal unit.

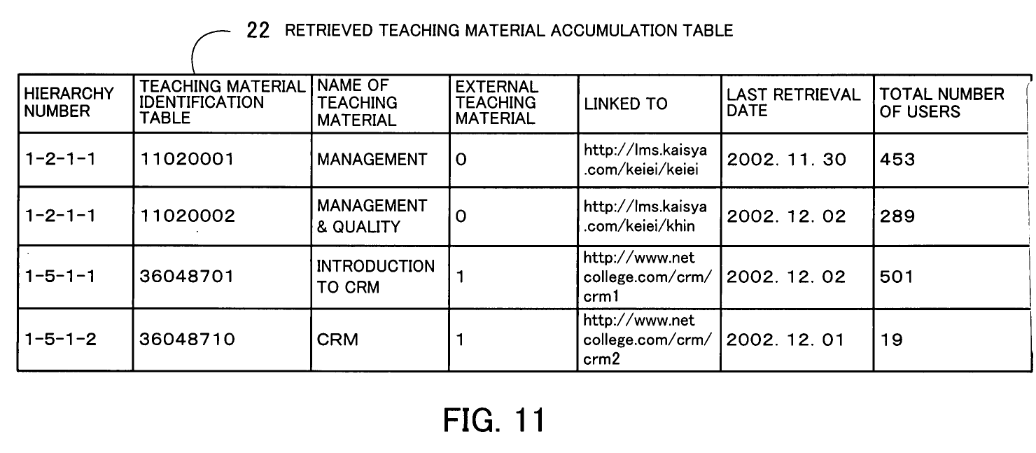

The retrieved teaching material accumulation table 22 shows how many times users retrieved teaching material content by a keyword. FIG. 11 shows an exemplary of the data structure of the retrieved teaching material accumulation table. As shown in FIG. 11, the retrieved teaching material accumulation table 22 contains columns labeled “Hierarchy Number”, “Teaching Material Identification Code”, “Name of Teaching Materials”, “External Teaching Materials”, “Linked to”, “Last Retrieval Date”, and “Total Number of Users”.

The hierarchy levels of transaction which users learned by retrieving teaching material content by a keyword are stored in the column “Hierarchy Number”. The identification numbers of the teaching material content which the users retrieved by a keyword to learn are stored in the column “Teaching Material Identification Code”. The names of the teaching material content which the users retrieved by a keyword to learn are stored in the column “Name of Teaching Materials”. Identifiers indicative of whether the teaching material content which the users retrieved by a keyword to learn was stored in the teaching material database 21 or in the external server 34 are stored in the column “External Teaching Materials”. In the column “External Teaching Materials” in FIG. 11, “0” indicates that teaching material content was stored in the teaching material database 21, and “1” indicates that teaching material content was stored in the external server 34. Places where the teaching material content which the users retrieved is linked are stored in the column “Linked to”. The last dates on which the users retrieved the teaching material content by a keyword are stored in the column “Last Retrieval Date”. The total numbers of the users who retrieved the teaching material content by a keyword to learn are stored in the column “Total Number of Users”.

In this example, the teaching material content corresponding to the teaching material identification code “11020001” was retrieved on a transaction screen corresponding to the hierarchy number “1-2-1-1”. The name of this teaching material content is “management” and it is stored in the teaching material database 21. This teaching material content is linked to “http://1ms.kaisha.com/keiei/keiei”. In addition, the last date on which this teaching material content was retrieved is Nov. 30, 2002. The total number of the users who retrieved this teaching material content is 453.

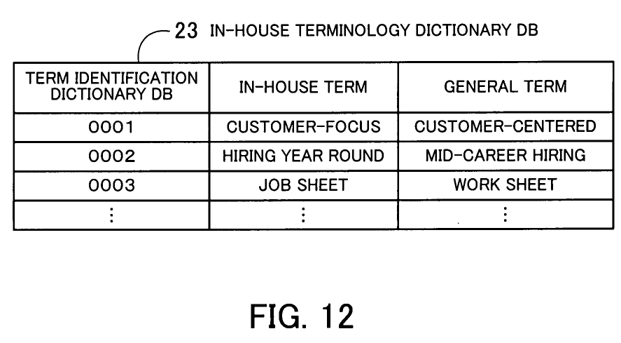

The in-house terminology dictionary database 23 shows the correspondence between transaction terminology employed in-house and transaction terminology generally employed. FIG. 12 shows an exemplary of the data structure of the in-house terminology dictionary database. As shown in FIG. 12, the in-house terminology dictionary database 23 includes columns labeled “Term Identification Code”, “In-house Term”, and “General Term”.

Identification numbers given to transaction terms are stored in the column “Term Identification Code”. Transaction terms employed in-house are stored in the column “In-house Term”. Transaction terms which have the same meanings as the in-house terms and which are generally used are stored in the column “General Term”.

In FIG. 12, an in-house term corresponding to the term identification code “0001” is “customer-focus”. A term which has the same meaning as the term “customer-focus” and which is generally used is “customer-centered”.

The control section 11 displays a transaction screen used by a user for conducting his/her transaction on each of the terminal units 31a through 31c. The control section 11 also displays teaching material content used by the user for transaction learning on each of the terminal unit 31a through 31c.

The control section 11 displays transaction items hierarchically on part of the screen of each of the terminal units 31a through 31c so that the user can select transaction arbitrarily by drill-down or drill-up. The hierarchy numbers in the transaction tree link table 19 shown in FIG. 8 are given to the transaction items displayed. When a transaction item is selected, the control section 11 refers to link data in the transaction tree link table 19 corresponding to the hierarchy number of the transaction item. Then the control section 11 obtains Web page data, an application program, and a sample file stored in the transaction database 18 in accordance with the link data, displays a Web page and the sample file on each of the terminal units 31a through 31c, and enables each of the terminal units 31a through 31c to execute the application program. The transaction items are displayed hierarchically, so the user can easily find transaction he/she wants to conduct.

When the user makes a learning request, the control section 11 refers to link data in the teaching material link table 20 corresponding to the hierarchy number of a transaction screen (transaction item) displayed on each of the terminal units 31a through 31c. Then the control section 11 obtains teaching material content stored in the teaching material database 21 in accordance with the link data and enables the user to learn with each of the terminal units 31a through 31c. Therefore, while the user is conducting his/her transaction displayed on each of the terminal units 31a through 31c, he/she should make a learning request for his/her transaction. By doing so, the user can learn about his/her transaction. That is to say, the user can easily learn about his/her transaction without seeking learning content for himself/herself.

Furthermore, on each of the terminal units 31a through 31c, the control section 11 displays a button used by the user for making a learning request.

The personal identification section 12 performs the process of authenticating a user who begins to conduct transaction. When the user begins to conduct transaction, he/she will input, for example, his/her user code and name from each of the terminal units 31a through 31c. The personal identification section 12 receives the user code and name inputted to each of the terminal units 31a through 31c and compares them with a user code and name stored in the user information database 16 to check whether they match.

The learning history management section 13 obtains the user code of a user who learned teaching material content, the teaching material code of the teaching material content, a hierarchy number, the date and hour at which the user began to learn, the date and hour at which the user finished learning, net learning time, and a learning flag and stores them in the learning history database 17.

The teaching material search section 14 obtains teaching material content. which matches a keyword sent from each of the terminal units 31a through 31c from the teaching material database 21. If teaching material content which matches the keyword sent from each of the terminal units 31a through 31c is not included in the teaching material database 21, then the teaching material search section 14 accesses the external server 34 possessed by the educational software vendor B to search for such teaching material content. If this keyword is an in-house term, then the teaching material search section 14 refers to the in-house terminology dictionary database 23, obtains a general term corresponding to the in-house term, and searches the server 34 for teaching material content with this general term as a keyword. The teaching material search section 14 stores the hierarchy number of a transaction screen where a user searched by a keyword, the place where teaching material content the user searched for by the keyword to learn is linked, the total number of users, etc. in the retrieved teaching material accumulation table 22.

The menu import section 15 refers to the retrieved teaching material accumulation table 22 and, in the case of the total number of users of teaching material content retrieved from the external server 34 having reached a predetermined number, stores information regarding the teaching material content in the teaching material link table 20. To be concrete, the menu import section 15 stores the hierarchy number of a transaction screen where a user retrieved the teaching material content, its title, teaching material identification code, and link data, and information indicative of whether external teaching materials exist in the teaching material link table 20. That is to say, the link data of teaching material content of an educational software vendor which is frequently retrieved by a keyword is stored in the teaching material link table 20. When a request to learn is made from one of the terminal units 31a through 31c the control section 11 refers to the teaching material link table 20 and displays teaching material content of an external educational software vendor on the terminal unit. As a result a user need not search for it by a keyword. Similarly, if teaching material content which matches a search keyword is included in the teaching material database 21 and the total number of users of the teaching material content has reached a predetermined number, then information regarding the teaching material content is stored in the teaching material link table 20. As a result, a user need not search the teaching material database 21 for it.

Screens displayed on the terminal units 31a through 31c will now be described.

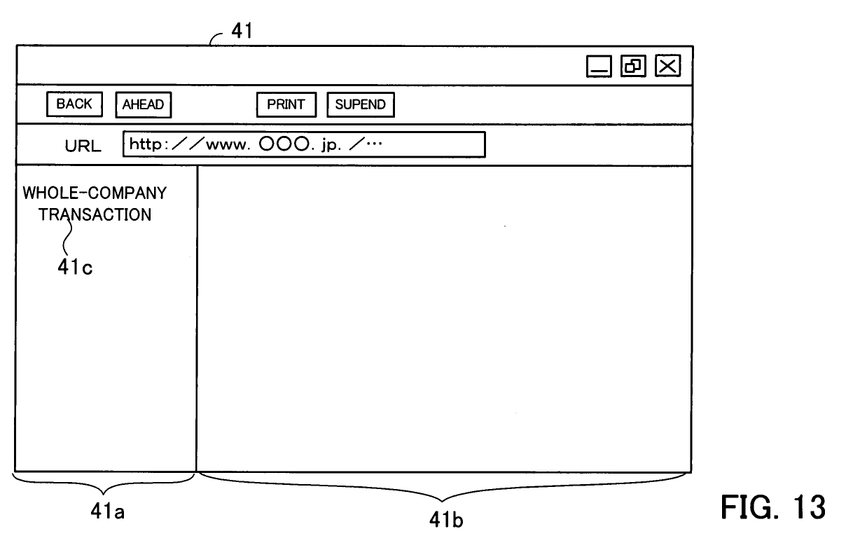

FIG. 13 shows a first transaction screen displayed on the terminal units. As shown in FIG. 13, a screen 41 is divided into areas 41a and 41b. Transaction items are displayed hierarchically in the area 41a. A transaction screen for conducting transaction is displayed in the area 41b. A tree text “whole-company transaction”41c is displayed in the area 41a. This whole-company transaction is a transaction item at the highest hierarchy level.

On the screen 41 displayed on each of the terminal units 31a through 31c, when a pointer is moved onto the tree text 41c with, for example, a mouse and the tree text 41c is double-clicked, transaction items the hierarchy level of which is lower than that of the transaction item “whole-company transaction” will be displayed.

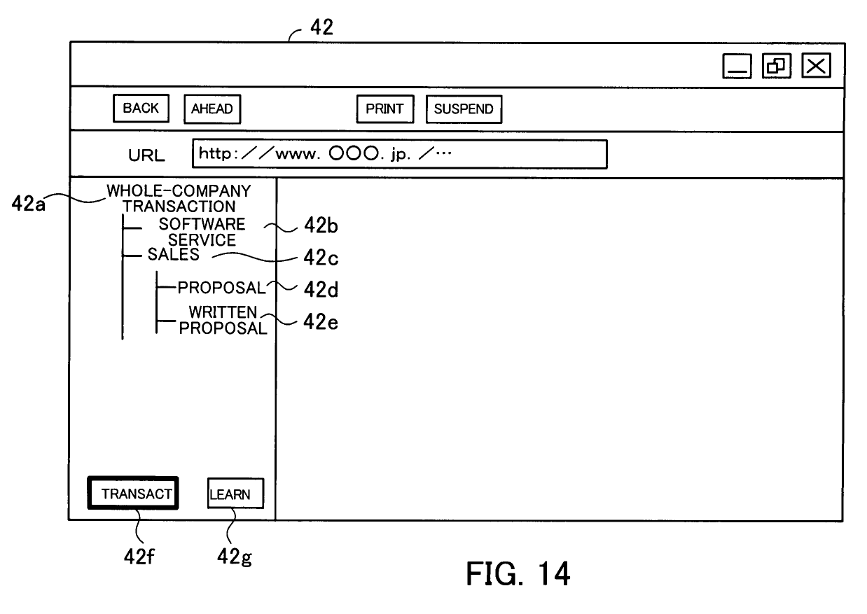

FIG. 14 shows a screen on the terminal units where transaction items at lower hierarchy levels are displayed. As shown in FIG. 14, tree texts “whole-company transaction” 42a, “software service” 42b, “sales” 42c, “proposal” 42d, and “written proposal” 42e are displayed on a screen 42. In addition a button 42f labeled “Transact” and a button 42g labeled “Learn” are displayed. In FIG. 14, the button 42f is indicated by a thick line, but really the button 42f will be colored to indicate that the screen 42 is for conducting transaction.

When the tree text 41c shown in FIG. 13 is double-clicked, the tree texts “software service” 42b and “sales” 42c shown in FIG. 14 will be displayed. When the tree text “sales” 42c is double-clicked, the tree texts “proposal” 42d and “written proposal” 42e will be displayed. The hierarchy level of the transaction items “proposal” and “written proposal” is lower than that of the-transaction item “sales”.

In FIG. 14, when the tree text “written proposal” 42e is double-clicked, a transaction screen for preparing a written proposal will be displayed.

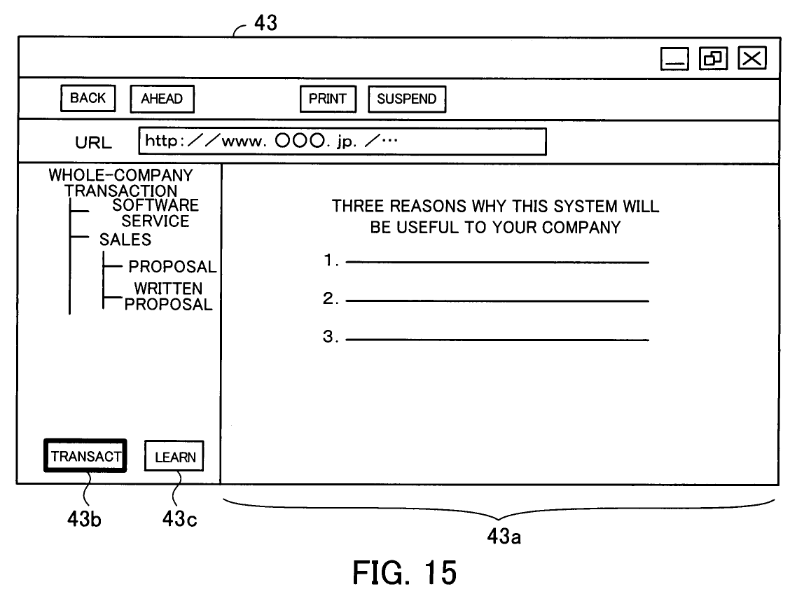

FIG. 15 shows a transaction screen displayed on the terminal units. As shown in FIG. 15, a transaction screen for preparing a written proposal is displayed in an area 43a on a screen 43. A user will prepare a written proposal on the basis of the written proposal displayed in the area 43a. In FIG. 15, the button 43b is indicated by a thick line, but really the button 43b will be colored to indicate that the screen 43 is for conducting transaction.

In FIG. 15, when a pointer is moved onto a button labeled “Learn” 43c and this button is clicked, a learning screen for learning how to prepare a written proposal will be displayed.

FIG. 16 shows a learning screen displayed on the terminal units. As shown in FIG. 16, texts “prepare a written proposal” 44a, “preface” 44b, “summary” 44c, “explanation” 44d, and “example” 44e are displayed on a screen 44. In addition a button 44f labeled “Transaction” and a button 44g labeled “Learn” are displayed. A text box 44h where a keyword is inputted, and a button 44i labeled “Search” for beginning a search by a keyword are also displayed. In FIG. 16, the button 44g is indicated by a thick line, but really the button 44g will be colored to indicate that the screen 44 is for performing learning.

When each of the texts 44b through 44e is double-clicked, the corresponding learning screen for preparing a written proposal will be displayed.

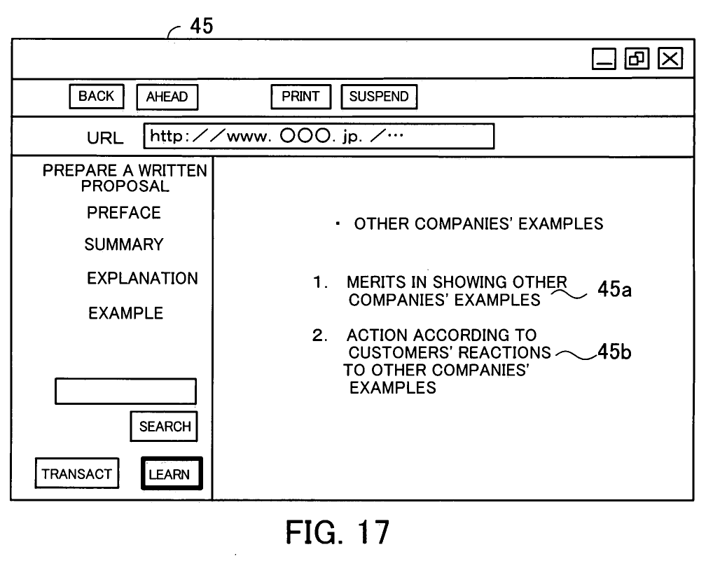

FIG. 17 shows a learning screen for learning how to describe an example which is displayed on the terminal units. A screen 45 shown in FIG. 17 will be displayed when the text “example” 44e shown in FIG. 16 is double-clicked.

Texts “1. Merits in showing other companies examples” 45a and “2. Action according to customers reactions to other companies examples” 45b are displayed on the screen 45. When a user moves a pointer onto each. of the texts 45a and 45b and clicks it, he/she can learn how to describe the corresponding item. In FIG. 17, a “Learn” button is indicated by a thick line, but really this button will be colored to indicate that the screen 45 is for performing learning.

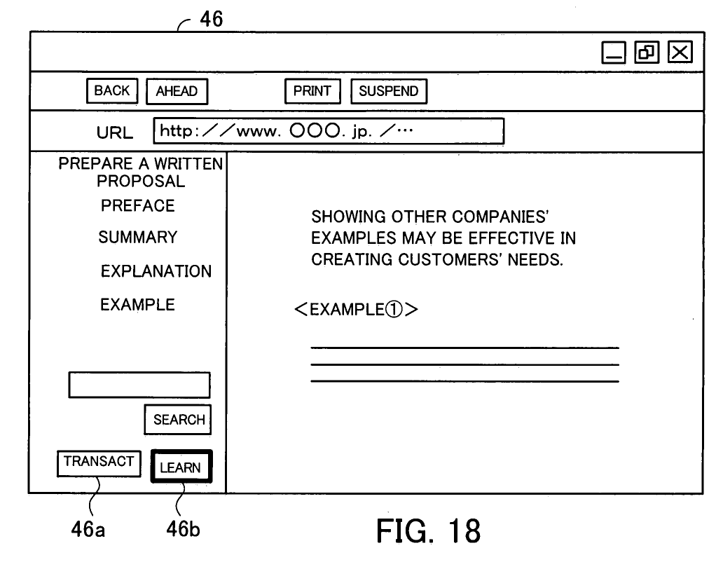

FIG. 18 shows a specific learning screen displayed. on the: terminal units. A screen 46 shown in FIG. 18 will be displayed when the text “1. Merits in showing another company's example” 45a shown in FIG. 17 is clicked. A button 46a labeled “Transact” and a button 46b labeled “Learn” are displayed on the screen 46. When a user finishes learning, he/she moves a pointer onto the button 46a and clicks it. As a result, the screen 43 shown in FIG. 15 will be displayed on each of the terminal units 31a through 31c.

In FIG. 18, the button 46b is indicated by a thick line, but really this button will be colored to indicate that the screen 46 is for performing learning.

If teaching material content suitable for a user learning does not exist, then he/she searches for such content by a keyword.

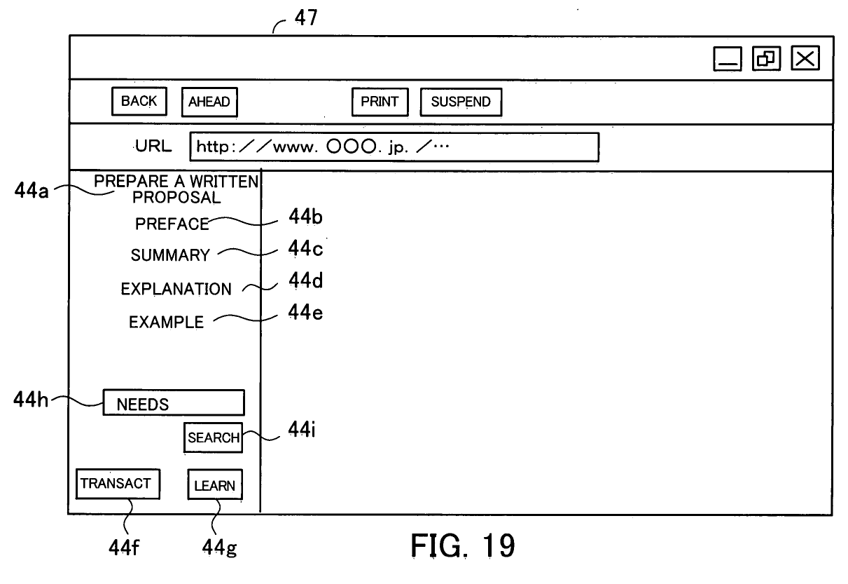

FIG. 19 shows a screen displayed on the terminal units at the time of searching by a keyword. By inputting the keyword “needs” in the text box 44h shown in FIG. 16, a screen 47 shown in FIG. 19 will be obtained. Components on the screen 47 which are the same as those on the screen 44 shown in FIG. 16 are marked with the same symbols and descriptions of them will be omitted.

By inputting the-keyword“needs” in a text box 44h, moving a pointer onto a button 44i labeled “Search”, and clicking it, teaching material content which matches the keyword will be searched for. If teaching material content which matches the keyword is not included in the teaching material database 21, then the server 10 will search the external server 34 possessed by the educational software vendor B for such teaching material content.

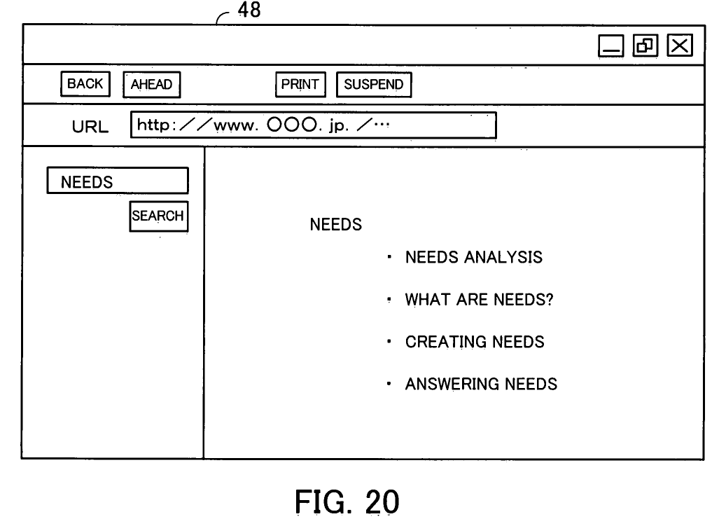

FIG. 20 shows the result of a search displayed on the terminal units. As shown in FIG. 20, the result of a search by a keyword is displayed on a screen 48. A user will click teaching material content he/she wants to learn from among the result of the search.

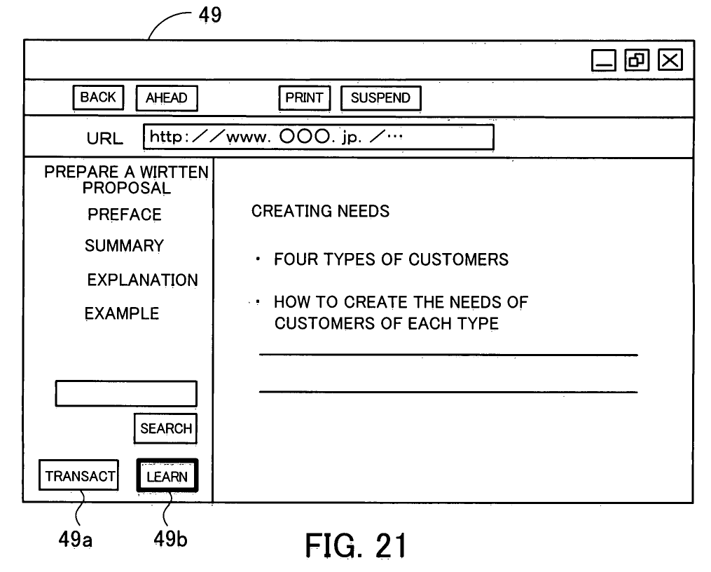

FIG. 21 shows a learning screen for learning teaching material content retrieved from an external server. Teaching material content retrieved is displayed on a screen 49 shown in FIG. 21. In addition, a button 49a labeled “Transact” and a button 49b labeled “Learn” are displayed. In FIG. 21, the button 49b is indicated by a thick line, but really this button will be colored to indicate that the screen 49 is for performing learning.

When a user finishes learning, he/she moves a pointer onto the button 49a and clicks it. As a result, the screen 43 shown in FIG. 15 will be displayed on each of the terminal units 31a through 31c.

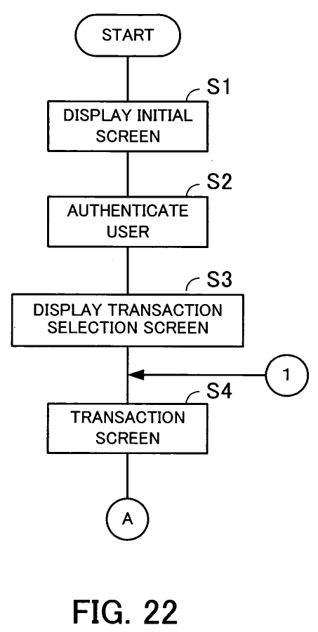

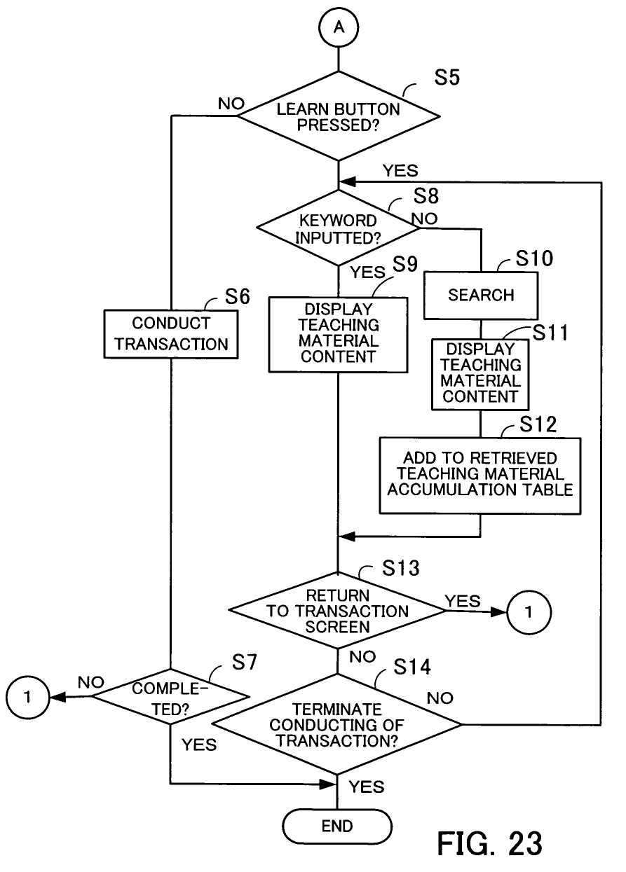

Now the operation of the transaction server 10 shown in FIG. 4, will be described with flow charts. FIG. 22 is flow chart 1 showing a process performed by the transaction server to provide transaction and teaching material content FIG. 23 is flow chart 2 showing a process performed by the transaction server to provide transaction and teaching material content.

[Step 1] The personal identification section 12 in the transaction server 10 displays an initial screen for identifying a user on each of the terminal units 31a through 31c when power is applied to it.

[Step 2] The personal identification section 12 receives the user code and name of the user from each of the terminal units 31a through 31c. The personal identification section 12 determines whether the user code and the name it received match a user code and a name, respectively, stored in advance in the user information database 16. If they match, then step S3 will be performed. If they do not match, then the personal identification section 12 will continue to receive a user code and a name.

[Step 3] The control section 11 displays a portal site, being an initial screen customized by the user solely for himself/herself, in response to a request from each of the terminal units 31a through 31c. The control section 11 refers to link data corresponding to the hierarchy number 1 at the top of the transaction tree link table 19 and obtains Web page data stored in the transaction database 18. The control section 11 sends the Web page data it obtained to each of the terminal units 31athrough 31c. Transaction items to select from are displayed hierarchically on each of the terminal units 31a through 31c.

[Step 4] The control section 11 displays a Web page and a sample file corresponding to transaction the user-selected arbitrarily by drill-down or drill-up on each of the terminal units 31a through. 31c. Furthermore, the control section 11 enables an application program to be executed on each of the terminal units 31athrough 31c. In addition the control section 11 displays a “Learn” button for accepting the user 7s learning request on each of the terminal units 31a through 31c.

[Step 5] The control section 11 checks whether the “Learn” button. displayed on the screen of each of the terminal units 31a through 31c is pressed. That is to say, the control section 11 checks whether the user was made a learning request. If the control section 11 judges that the “Learn” button is not pressed, then step S6 will be performed. If the control section 11 judges that the “Learn” button is pressed, then step S8 will be performed.

[Step 6] The control section 11 conducts the transaction in response to a request from each of the terminal units 31a through 31c.

[Step 7] The control section 11 receives information indicative of whether the transaction is completed from each of the terminal units 31athrough 31c. If the control section. 11 receives information indicative that the transaction is finished from each of the terminal units 31a through 31c, then the control section 11 will terminate the process. If the control section 11 receives information indicative that the transaction is not finished from each of the terminal units 31a through 31c then step S4 will be-performed.

[Step 8] The control section 11 obtains the hierarchy number of a transaction screen displayed on each of the terminal units 31a through 31cat the time of the “Learn” button being pressed. Then the control section 11 refers to the corresponding hierarchy number in the teaching material link table 20 and obtains teaching material content stored in the teaching material database 21 on the basis of link data. The control section 11 displays the teaching material content on each of the terminal units 31a through 31c.

If the teaching material content displayed on each of the terminal units 31a through 31c is exactly what the user wants to learn, then he/she will learn about it If the teaching material content displayed on each of the terminal units 31a through 31c is not exactly what the user wants to learn, then he/she will search for such teaching material content by a keyword.

The control section 11 checks whether a search by a keyword is performed from each of the terminal units 31a through 31c. If a keyword is not inputted, then the control section 11 will perform step S9. If a keyword is inputted, then the control section 11 will perform step S10.

[Step 9] The control section 11 displays teaching material content requested by the user on each of the terminal units 31a through 31c.

[Step 10] The teaching material search section 14 in the transaction server 10 obtains teaching material content which matches the keyword sent from each of the terminal units 31a through 31c from the teaching material database 21. If teaching material content which matches the keyword sent from each of the terminal units 31a through 31c is not included in the teaching material database 21, then the teaching material search section 14 accesses the external server 34 possessed by the educational software vendor B to search for such teaching material content. If this keyword is an in-house term, then the teaching material search section 14 refers to the in-house terminology dictionary database 23, obtains a general term corresponding to the in-house term, and searches the server 34 for teaching material content with the general term as a keyword.

[Step 11] The control section 11 displays teaching material content retrieved on each of the terminal units 31a through 31c.

[Step 12] The teaching material search section 14 stores the hierarchy number of transaction for which the search by the keyword was performed, the place where the retrieved teaching material content is linked, the total number of users of the teaching material content, and the like in the retrieved teaching material accumulation table 22.

[Step S13] The control section 11 judges whether a request to return to the transaction screen (the conducting of the transaction) is made from each of the terminal units 31a through 31c. If a request to return to the transaction screen is made, then the control section 11 will perform step S4. If a request to return to the transaction screen is not made, then the control section 11 will perform step S14.

[Step 14] The control section 11 decides whether a request to terminate the conducting of the transaction is made from each of the terminal units 31a through 31c. If a request to terminate the conducting of the transaction is made, then the control section 11 will terminate the conducting of the transaction. If a request to terminate the conducting of the transaction is not made, then the control section 11 will perform step S8.

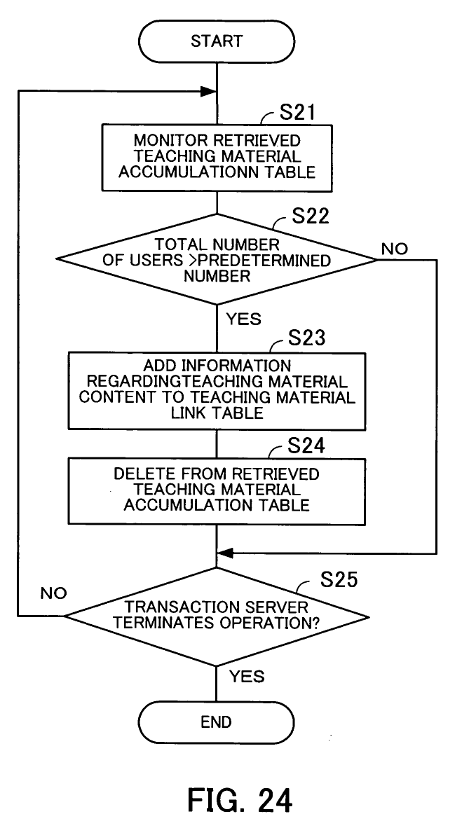

FIG. 24 is a flow chart showing a process performed by the transaction server to add teaching material content to the teaching material database.

[Step 21] The menu import section 15 refers to the retrieved teaching material accumulation table 22 and obtains the total number of users of teaching material content retrieved from the external server 34 possessed by the educational software vendor B.

[Step 22] The menu import section 15 judges whether the total number of users of the teaching material content has reached a predetermined number. If the menu import section 15 judges that the total number of users of the teaching material content has reached the predetermined number, then the menu import section 15 will perform step S23. If the menu import section 15 judges that the total number of users of the teaching material content has not reached the predetermined number, then the menu import section 15 will perform step S25.

[Step 23] The menu import section 15 refers to the retrieved teaching material accumulation table 22 and stores the hierarchy number of the teaching material content in the external server 34 of the educational software vendor B the total number of users of which has reached the predetermined number, the place where this teaching material content is linked, etc. in the column “HierarchyNumber”, “LinkData”, etc. respectively, in the teaching material link table 20.

[Step S24] The menu import section 15 deletes information regarding the teaching material content added to the teaching material link table 20 from the retrieved teaching material accumulation table 22.

[Step S25] When the transaction server 10 does not terminate its operation, the menu import section 15 will perform step S21. When the transaction server 10 terminates its operation, the menu import section 15 will also terminate the process.

As stated above, when a learning request for transaction is made on a transaction screen, teaching material content for learning about the transaction on the transaction screen is displayed on each of the terminal units 31a through 31c. If teaching material content is searched for by a keyword on a transaction screen and such teaching material content is not included in the teaching material database 21, then it is retrieved from the external server 34 and is displayed on each of the terminal units 31a through 31c. Therefore, by making a request on a transaction screen to learn, a user can easily learn about his/her transaction. Furthermore, if teaching material content a user wants to learn is not included in the teaching material database 21, such teaching material content is retrieved from the external server 34. Accordingly, even if the teaching material database 21 does not include teaching material content a user wants to learn, he/she can learn about it.

In addition, link data for teaching material content of an educational software vendor frequently searched for by a keyword is stored in the teaching material link table 20. As a result, when a request to learn is made from each of the terminal units 31a through 31c, the control section 11 refers to the teaching material link table 20 and displays teaching material content of an external educational software vendor on each of the terminal units 31a through 31c. A user therefore can learn teaching material content easily without searching for it by a keyword.

Moreover, if a keyword is a transaction term employed in-house, then it will be converted to a transaction term generally used before performing a search. Accordingly, the range of teaching material content to be searched for will expand.

The above functions can be realized with a computer. In this case, the contents of the functions the transaction server 10 should have are described in a program recorded on a computer readable record medium. By executing this program on a computer, the above processes will be performed on the computer. A computer readable record medium can be a magnetic recording device, a semiconductor memory, or the like. To place the program on the market, it is stored on portable record media, such as compact disk read only memories (CD-ROMs) and flexible disks. Alternatively, the program is stored in advance on a hard disk in a computer connected via a network and is transferred to another computer via the network. When this program is executed on a computer, the program stored in advance on its hard disk or the like will be loaded into its main memory.

As has been described in the foregoing, in the present invention, when a learning request for transaction is made on a transaction screen on a terminal unit, learning content for learning about the transaction is displayed on the terminal unit. Learning content is searched for on the transaction screen by a keyword, and if learning content which matches the keyword does not reside in a database stored in the computer, it is retrieved from an external server and is displayed on the terminal unit.

As a result, when a learning request is made on a transaction screen, learning content for learning about transaction displayed on the transaction screen is provided. A user therefore can learn about his/her transaction easily.

In addition, even if learning content a user wants to learn does not reside on a computer, it will be retrieved from an external server by a keyword. The user therefore can learn the learning content he/she wants to.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A business transaction program for conducting transaction, the program making a computer perform the processes of:
displaying a transaction screen used by a user for conducting transaction on a terminal unit in response to a request from the terminal unit;
displaying learning content for learning about the transaction to be conducted on the transaction screen on the terminal unit in the case of a learning request for the transaction being made on the transaction s screen displayed on the terminal unit; and
retrieving, in case the learning content is searched on the transaction screen by a keyword and learning content which matches the keyword does not reside in a database stored in the computer, learning content which matches the keyword from an external server and displaying the learning content on the terminal unit.

2. The business transaction program according to claim 1, wherein:
corresponding identifiers are given to the transaction screen and the learning content respectively; and
when the learning request is made on the transaction screen displayed on the terminal unit, the identifier of the transaction screen is referred to and the learning content is displayed.

3. The business transaction program according to claim 1, wherein a learning button for making the learning request is displayed on the transaction screen.

4. The business transaction program according to claim 1, wherein:
hierarchical structure of the transaction is displayed on the transaction screen; and
the transaction screen is displayed by drilling up or down the hierarchical structure.

5. The business transaction program according to claim 1, wherein:
number of times the learning content is retrieved from the external server is counted by kinds; and
when the number of times the learning content is retrieved from the external server reaches a predetermined number, link information for the learning content is registered with a link information database.

6. The business transaction program according to claim 5, wherein the learning content is accessed on the basis of the link information and is displayed on the terminal unit.

7. The business transaction program according to claim 1, wherein if the keyword is a term employed in-house, the keyword is converted to a general term.

8. A computer-readable record medium that stores a program for conducting transaction, the program making a computer perform the processes of:
displaying a transaction screen used by a user for conducting transaction on a terminal unit in response to a request from the terminal unit;
displaying learning content for learning about the transaction to be conducted on the transaction screen on the terminal unit in the case of a learning request for the transaction being made on the transaction screen displayed on the terminal unit; and
retrieving, in case the learning content is searched for on the transaction screen by a keyword and learning content which matches the keyword does not reside in a database stored in the computer, learning content which matches the keyword from an external server and displaying the learning content on the terminal unit.
